(19) United States
(12) Patent Application Publication
(10) Pub. No.: US 2014/0028522 A1
(43) Pub. Date: Jan. 30, 2014

(54) COVER HAVING AN ANTENNA RADIATING ELEMENT FOR A WIRELESS ACCESS POINT

(71) Applicant: Theodore J. Wheeler, Roseville, CA (US)

(72) Inventor: Theodore J. Wheeler, Roseville, CA (US)

(21) Appl. No.: 13/557,287

(22) Filed: Jul. 25, 2012

(51) Int. Cl. H01Q 1/40; H01P 11/00

(52) U.S. Cl. 343/873; 29/600

(57) ABSTRACT

An antenna assembly includes a cover having a plurality of layers including electrical insulator layers and an antenna radiating element between the electrical insulator layers.

### BACKGROUND

A wireless access point includes a communications node that is able to communicate wirelessly with wireless devices. The wireless access point provides a wireless link to a wireless device to allow the wireless device to connect to a network for communication with other devices coupled to the network.

### BRIEF DESCRIPTION OF THE DRAWINGS

Some embodiments are described with respect to the following figures:

FIG. 1 is a schematic diagram of an example arrangement that includes a wireless access point and a cover that has an antenna radiating element, in accordance with some implementations;

FIG. 2 is a schematic diagram of an example cover having an antenna radiating element according to alternative implementations;

FIGS. 3 and 4 are cross-sectional views of covers each having an antenna radiating element (or antenna radiating elements), in accordance with various implementations;

FIG. 5 is a schematic diagram depicting a connector on a cover for connection to a coaxial cable, in accordance with some implementations;

FIG. 6 is a schematic top view of a cover according to some implementations; and

FIG. 7 is a flow diagram of a process of making an antenna assembly, according to some implementations.

### DETAILED DESCRIPTION

Wireless connectivity can be offered to users at various locations. The locations can include establishments such as hotels, conference centers, airports, retail shops, restaurants, airplanes, ships, and so forth. The locations can also include facilities of enterprises (e.g. business concerns, educational organizations, and government agencies), where wireless connectivity can be provided to employees of the enterprise. In addition, wireless connectivity can also be provided in a home.

Wireless connectivity can be provided by placing one or multiple wireless access points at specific location(s) in an area where wireless connectivity is to be provided to users. Wireless links can be established between each wireless access point and wireless devices within a range of the corresponding wireless access point. Examples of wireless devices include desktop computers, notebook computers, tablet computers, personal digital assistants (PDAs), smartphones, game appliances, television set-top boxes, and so forth.

In certain contexts, it may be desirable to place wireless access points in locations where the wireless access points are hidden from view, which can be for aesthetic reasons, or for other reasons. As an example, in a hotel room, a wireless access point can be positioned in a recess within a wall of the hotel room, with a cover placed over the recess to hide the wireless access point in the recess. In other examples, wireless access points can similarly be placed in other secluded locations.

Positioning a wireless access point in a secluded location, such as in a recess behind a wall, can result in relatively weak wireless links between the wireless access point and wireless devices. For example, obstructions around the wireless access point can interfere with the communication of wireless signals between the wireless access point and a wireless device. Examples of obstructions can include a container (such as a junction box) in which the wireless access point is located, a heat sink in the proximity of the wireless access point, and the wall between the wireless access point and the room where the wireless device is located. A relatively weak wireless link between a wireless access point and a wireless device can lead to unreliable communications or relatively slow data rates over the wireless link.

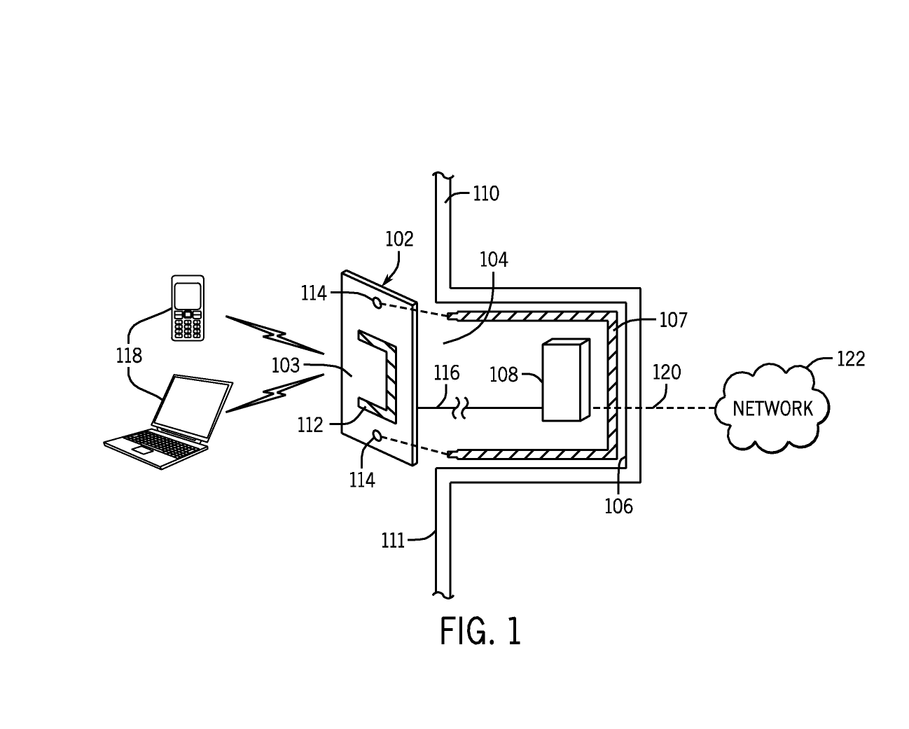

In accordance with some implementations, to provide wireless links with enhanced strength with a wireless access point that is positioned in a secluded location, an antenna associated with the wireless access point can be placed in a structure that is remotely located from the wireless access point such that the antenna is less likely to be affected by obstructions that can interfere with wireless signal communication. FIG. 1 illustrates an example arrangement in which an antenna is provided in a cover 102 that is arranged to be placed over an opening 104 of a recess 106 in which a wireless access point is to be positioned. A “cover” can refer to any structure that is to be used for placement over an opening to fully or partially block or close up the opening.

In some examples, the recess 106 is defined in a wall 110 of a room, such as a hotel room, a conference room, a room at home, and so forth. As further examples, the wall 110 can be the wall in an airport, a wall of a vehicle such as an airplane, car, or ship, a wall in the facilities of an enterprise, and so forth. In other examples, the recess 106 can be defined in a different infrastructure, such as furniture, home appliances, and so forth.

In some implementations, the wireless access point 108 can be located inside a junction box 107 that is placed in the recess 106. The junction box 107 can be formed of a metal or other material. In addition, a heat sink (not shown) can be positioned in the proximity of the wireless access point 108 for cooling the wireless access point 108. The presence of the junction box and the heat sink, as well as the presence of the wall 110, can interfere with wireless communication of the wireless access point 108, if an antenna were provided on the wireless access point 108 in the arrangement shown in FIG. 1.

In accordance with some implementations, the antenna associated with the wireless access point includes a radiating element 112 (formed of an electrically conductive material) that is integrated within the cover 102. As discussed further below, the antenna radiating element 112 is provided between electrical insulator layers of the cover 102. The cover 102 is a standalone structure that is separate from the wireless access point 108, and is positioned away from the recess 106 such that the cover 102 is spaced apart from the junction box 107, the heat sink, and any other obstruction that may be located in the recess 106.

The cover 102 is configured to be attached to the junction box 107, in some examples. For example, screw holes 114 can be provided in the cover 114, to allow screws to pass through the screw holes 114 to attach to threaded openings in the junction box 107. In other examples, other mechanisms for attaching the cover 102 to the junction box 107 can be employed. As yet further examples, the cover 102 can instead be attached to the wall 110, instead of to the junction box 107.

More generally, the cover 102 is removably attached to an infrastructure that includes the recess 106 that contains the wireless access point 108, where the infrastructure can be the junction box 107, the wall 102, or any other fixed structure separate from the wireless access point 108 to which the cover 102 can be attached.

Once the cover 102 is attached to the infrastructure, a front face 103 of the cover 102 can generally be flush with a front surface 111 of the wall 110. Alternatively, the front face 103 can protrude slightly from the front surface 111 of the wall 110, or the front face 103 can be recessed slightly inside of the front surface 111 of the wall 110.

The antenna radiating element 112 is interconnected by a link 116 (e.g. a coaxial cable or any other type of electrical link) to the wireless access point 108. The antenna radiating element 112 is able to emit and receive wireless signals (e.g. radio frequency signals). Wireless devices 118 within the range of the wireless access point 107 can communicate wirelessly with the wireless access point 108 through the antenna in the cover 102.

As further shown in FIG. 1, the wireless access point 108 can be coupled over a link 120 to a network 122. The network 122 can be a local area network, a wide area network, the Internet, and so forth.

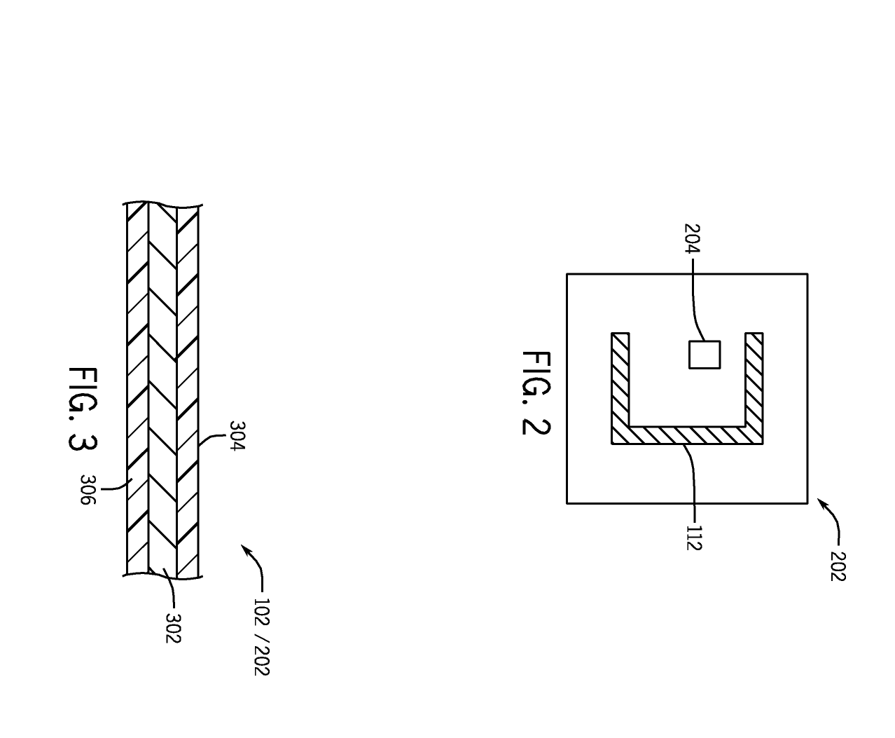

In some examples, the cover 102 can be a blank cover that is without any openings for electrical connectors, such a network port receptacle, telephone jack, power outlet, and so forth. In other examples, such as according to FIG. 2, the antenna radiating element 112 can be provided in a cover 202 that has an opening 204 for an electrical connector, such as any of the foregoing types of electrical connectors. Although just one opening 204 is depicted in FIG. 2, it is noted that in other examples, the cover 202 can include multiple openings for multiple corresponding electrical connectors. Although the opening 204 is generally rectangular in shape, it is noted that the opening 204 can have other shapes in other examples.

FIG. 3 is a cross-sectional view of a portion of the cover 102 or 202. An electrically conductive layer 302 that is used to form a part of the antenna radiating element 112 is sandwiched between electrical insulator layers 304 and 306. For example, the insulator layer 304 can be part of the front outermost layer of the cover 102 or 202. Although just two insulator layers and one electrically conductive layer 302 is depicted in FIG. 3, it is noted in alternative implementations, there can be a larger number of insulator layers and electrically conductive layers.

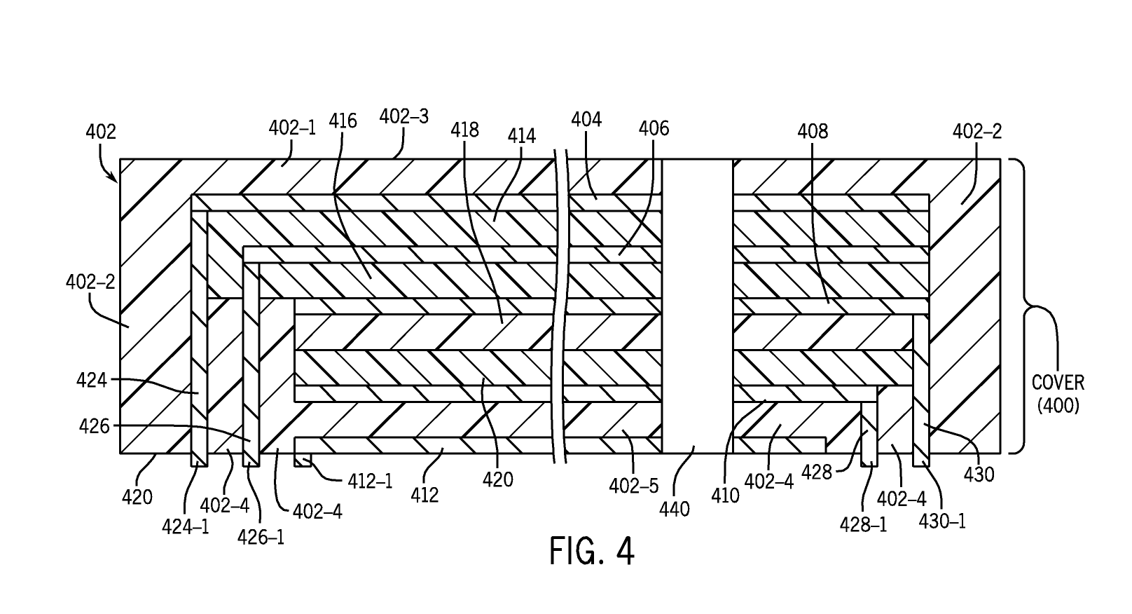

FIG. 4 is a cross-sectional view of a cover 400 according to further implementations. In the example of FIG. 4, the cover 400 has multiple electrically conductive layers and multiple electrical insulator layers. The electrically conductive layers of the cover 400 can form one or multiple corresponding antenna radiating elements. Note that the various structures depicted in FIG. 4 are to provide a schematic representation of the structures of the cover 400, and are not drawn to scale.

The arrangement of FIG. 4 can be formed using any of various manufacturing techniques, including, as examples, the following: an injection molding technique, a stereolithography technique, a three-dimensional (3D) printing technique, a low-temperature cofired ceramic technique, or a manual layering and adhesion technique.

An outside encapsulant structure 402, formed of an electrical insulator material, is provided to encapsulate various internal structures that are part of the cover 400. The outer encapsulant structure 402 includes a surface layer 402-1 and side portions 402-2 that cover the sides of the cover 400. In examples according to FIG. 4, the side portions 402-2 generally extend the full width of the cover 400 (in the vertical direction in FIG. 4). The surface layer 402-1 has a front side 402-3 that is visible to users when the cover 400 is attached to an infrastructure (such as the junction box 107 or wall 110 of FIG. 1) that contains a wireless access point.

In examples according to FIG. 4, the outer encapsulant structure 402 fully encapsulates the various internal structures of the cover 400. Portions 402-4, 402-5 of the outer encapsulant structure 402 can also fill any gaps inside the cover 400 that may not be occupied by other internal structures of the cover 400. In other examples, instead of using the electrical insulator layer 402-5 that is part of the outer encapsulant structure 402, a different electrical insulator layer can be used instead.

As depicted in FIG. 4, the cover 400 has several electrically conductive layers 404, 406, 408, 410, and 412. The electrically conductive layers 404, 406, 408, 410, and 412 can be formed of the same electrically conductive material or different electrically conductive materials. Moreover, within each electrically conductive layer, one or multiple different electrically conductive materials can be used. The thicknesses of the electrically conductive layers 404, 406, 408, 410, and 412 can be the same or can be different.

Each electrically conductive layer can be formed of a metal, electrically conductive ink, or any other type of electrically conductive material. An electrically conductive layer can be flexible or rigid. An electrically conductive layer can have one or multiple openings to allow vias to pass through the opening(s).

Corresponding electrical insulator layers 414, 416, 418, and 420, and 402-5 can be provided between each successive pair of electrically conductive layers in the arrangement of FIG. 4. An electrical insulator layer can be flexible or rigid. The electrical insulator layers 414, 416, 418, and 420, and 402-5 can be formed of the same or different electrical insulator materials. Moreover, within each electrical insulator layer, one or multiple different electrical insulator materials can be used. The thicknesses of the electrical insulator layers 414, 416, 418, and 420, and 402-5 can be the same or can be different.

Examples of electrical insulator materials can include any or some combination of the following: plastic, glass, Styrofoam, aerogel, paper, ceramic, and any other insulator material. In some examples, the insulator material is one that has a relatively low dielectric loss tangent to reduce dissipation of electromagnetic (EM) energy of EM signals communicated with the electrically conductive layers. In further examples, the outer encapsulant structure 402 has a dielectric constant that is relatively close to that of air to reduce a mismatch in dielectric constants between the outer encapsulant structure 402 and air to reduce boundary reflective loss during transmission of EM energy.

The electrical insulator layers and electrically conductive layers may or may not be center aligned, which means that a center of a given electrically conductive layer may not align with a center of a given electrical insulator layer.

Although specific layers are depicted in FIG. 4, it is noted that in different examples, other layer arrangements can be provided, including arrangements with different numbers of electrically conductive layers and electrical insulator layers. Note also that between each successive pair of electrically conductive layers, one or multiple electrical insulator layers can be provided.

As further depicted in FIG. 4, electrically conductive via structures can also be provided that electrically contact the respective electrically conductive layers 404, 406, 408, and 410. For example, a via structure 424 electrically contacts the conductive layer 404 and extends through various layers of the cover 400 to an inner side 420 of the cover 400. The inner side 420 of the cover 400 is on the opposite side of the cover 400 from the front side 402-3.

A portion 424-1 of the via structure 424 protrudes past the inner side 420 of the cover 400. The protruding portion 424-1 of the via structure 424 allows an electrical connection to be made to the via structure 424.

Via structures 426, 428, and 430 similarly are electrically contacted to respective ones of the electrically conductive layers 406, 410, and 408, and extend from these respective electrically conductive layers through various layers of the cover 400 to the inner side 420 of the cover 400. A protruding portion 426-1, 428-1, or 430-1 of each via structure 426, 428, or 430, respectively, protrudes partially past the inner side 420 of the cover 400 to allow electrical connection to be made to the via structures 426, 428, and 430. The protruding portions 424-1, 426-1, 428-1, and 430-1 provide respective electrical connection points, according to some examples.

Although via structures 424, 426, 428, and 430 are depicted as being contacted to end portions of respective ones of the electrically conductive layers 404, 406, 410, and 408, in different examples, a via structure can be contacted to another portion of the corresponding electrically conductive layer.

In some examples, the electrically conductive layers 404, 406, 408, and 410 can be used as one or multiple antenna radiating elements. If all the conductive layers 404, 406, 408, and 410 are electrically connected with each other, then these conductive layers effectively form a single antenna radiating element. However, the electrically conductive layers can be part of corresponding different antenna radiating elements.

More generally, each of the electrically conductive layers 404, 406, 408, and 410 can be part of corresponding different antennas, or part of the same antenna. As further examples, the different electrically conductive layers 404, 406, 408, and 410 can be used to communicate in different frequency bands.

Each of the electrically conductive layers 404, 406, 408, and 410 can have any of various possible patterns. The pattern of an electrically conductive layer can include a linear strip, a rectangular pad, or can be a more complex pattern.

The electrically conductive layer 412 that is adjacent to the inner side 420 of the cover 400 can be used as a ground layer. A connection portion 412-1 protrudes past the inner side 420 of the cover 400 to allow electrical connection to be made to the ground layer 412.

In different examples, instead of using the electrically conductive layer 412 as the ground layer, one of the electrically conductive layers 404, 406, 408, and 410 can be used as the ground layer.

FIG. 4 also shows a cutout groove 440 that extends through the various layers of the cover 202, from the front side 402-3 of the cover 202 to the inner side 420. The cutout groove 440 can be used for an electrical connector, such as a network port receptacle, a telephone jack, a power outlet, and so forth.

In different examples, instead of using the outer encapsulant structure 402 that fully encapsulates various internal structures of the cover 400, a partial encapsulant structure that partially encapsulates some inner structures of the cover 400 can be used instead. Such a partial encapsulant structure can include the surface layer 402-1 and modified side portions 402-2 that partially encapsulates the sides of the cover 400 (the modified side portions 402-2 do not extend the full width of the cover 400).

In implementations that employ a partial encapsulant structure, portions of the inner structures of the cover 400 not encapsulated by the partial encapsulant structure can be protected using other insulator materials, such as insulator materials corresponding to any of the insulator layers 414, 416, 418, and 420. Any of the insulator layers 414, 416, 418, and 420 can be extended in a vertical direction (in the view of FIG. 4) to fill any gaps between inner structures of the cover 400. Alternatively, insulator materials can be injected into any gaps between inner structures of the cover 400.

As yet another example, instead of using an encapsulant structure that either fully or partially encapsulates inner structures of the cover 400, an encapsulant structure can be omitted. Effectively, the outermost layer (corresponding to layer 402-1, for example) is just another electrical insulator layer (without any side portions for encapsulating purposes) in a stack of layers.

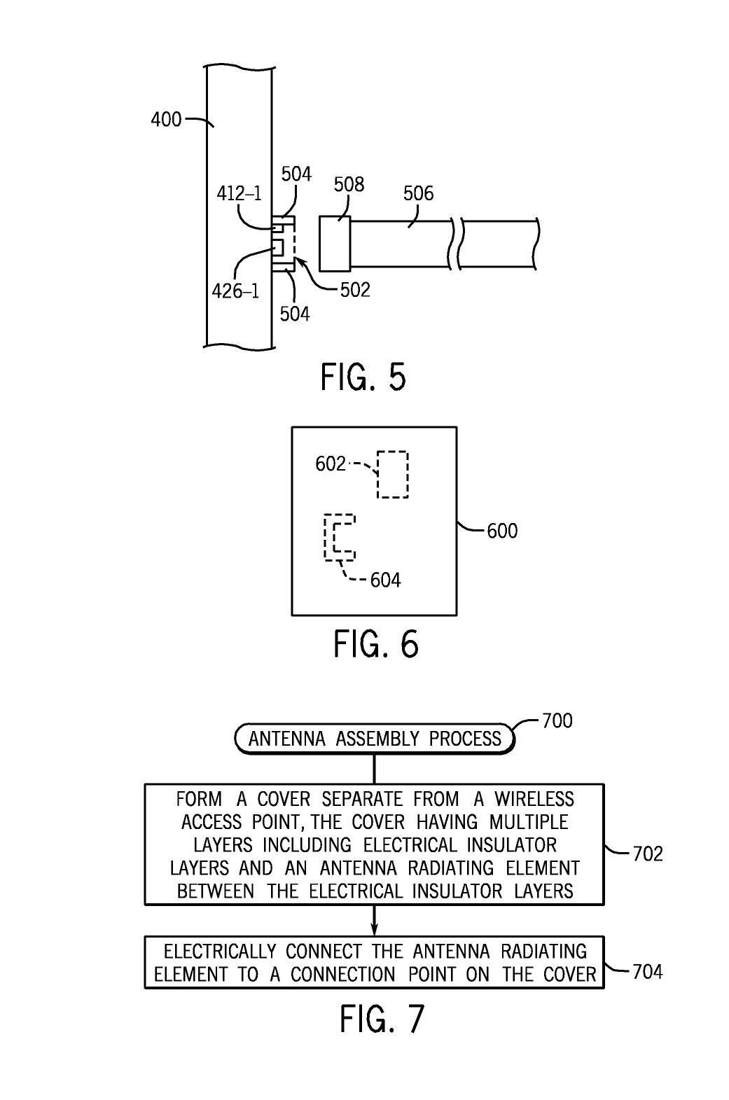

FIG. 5 is a schematic diagram showing electrical connection to electrically conductive structures of the cover 400. For simplicity, just the via protruding portion 426-1 and ground layer connection portion 412-1 are shown in FIG. 5. The via protruding portion 426-1 can be provided in the middle of a connector 502. A cylindrical structure 504 that forms the outer housing of the connector 502 can be electrically contacted to the ground layer connection portion 412-1.

The connector 502 is configured for connection to a coaxial cable 506. A connection sleeve 508 can be threadably or otherwise engaged to the connector 502, to allow electrical connection between electrically conductive structures of the coaxial cable 506 and the corresponding via protruding portion 426-1 and ground layer connection portion 412-1.

There can be different example types of coaxial cables. A first type of coaxial cable has a center conductor (for carrying radio frequency signals, for example), and an outer ground shield around the center conductor. A second type of coaxial cable has multiple inner conductors for carrying radio frequency signals, for example, and an outer ground shield around the multiple inner conductors. A third type of coaxial cable can have a parallel arrangement of conductors for carrying radio frequency signals with an outer ground shield as well as ground shields provided between each successive pair of conductors.

It is noted that the electrically conductive layers of the cover do not have to be aligned with respect to each other. For example, in a top view of a cover 600 as shown in FIG. 6, a first electrically conductive layer 602 can be positioned at a first location, while a second electrically conductive layer 604 (in a different layer than the first electrically conductive layer 602 in the stack of layers making up the cover 600) can be positioned at a second location. Via structures can similarly be located in different locations of the cover.

FIG. 7 is a flow diagram of a process 700 of making an antenna assembly for a wireless access point, according to some implementations. The process 700 includes forming (at 702) a cover that is separate from the wireless access point, where the cover has multiple layers including electrical insulator layers and an antenna radiating element between the electrical insulator layers.

The process 700 further electrically connects (at 704) the antenna radiating element to an electrical connection point (e.g. one of via protruding portions 424-1, 426-1, 428-1, and 430-1 of FIG. 4) on the cover for electrical communication to the wireless access point.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. An antenna assembly comprising:
a cover configured to attach to an infrastructure having a wireless access point, the cover having a plurality of layers including electrical insulator layers and an antenna radiating element between the electrical insulator layers.

2. The antenna assembly of claim 1, wherein the cover has an opening for an electrical connector.

3. The antenna assembly of claim 1, wherein the cover has an electrical connection point electrically connected to the antenna radiating element, wherein the electrical connection point is for electrical coupling to the wireless access point.

4. The antenna assembly of claim 1, wherein the plurality of layers include a first electrically conductive layer that forms at least part of the antenna radiating element.

5. The antenna assembly of claim 4, wherein the plurality of layers further include a second electrically conductive layer.

6. The antenna assembly of claim 5, wherein the second electrically conductive layer is also part of the antenna radiating element.

7. The antenna assembly of claim 5, wherein the second electrically conductive layer is part of another antenna radiating element.

8. The antenna assembly of claim 5, further comprising via structures that are electrically contacted to respective ones of the first and second electrically conductive layers, and wherein the via structures extend through the plurality of layers to protrude from an inner side of the cover.

9. The antenna assembly of claim 1, wherein the cover is configured to attach to the infrastructure to partially or fully block an opening of a recess that contains the wireless access point.

10. The antenna assembly of claim 1, wherein the cover is a standalone structure that is separate from the wireless access point.

11. An apparatus comprising:
a wireless access point accessible wirelessly by wireless devices to access a network; and
a cover that is separate from the wireless access point and having a plurality of layers including electrical insulator layers and an antenna radiating element between the electrical insulator layers.

12. The apparatus of claim 11, further comprising an electrical link to electrically couple the antenna radiating element to the wireless access point.

13. The apparatus of claim 11, wherein the cover is configured to be removably attached to an infrastructure for containing the wireless access point.

14. The apparatus of claim 13, wherein the cover is to fully or partially block an opening to a recess in the infrastructure, the recess to contain the wireless access point.

15. The apparatus of claim 14, wherein the cover is configured to attach to a junction box in the recess, where the junction box is to contain the wireless access point.

16. The apparatus of claim 11, wherein the plurality of layers include a first electrically conductive layer that forms part of the antenna radiating element.

17. The apparatus of claim 16, wherein the plurality of layers include a second electrically conductive layer that forms part of the antenna radiating element or another antenna radiating element.

18. A method of making an antenna assembly for a wireless access point, comprising:
forming a cover separate from the wireless access point, wherein the cover has a plurality of layers including electrical insulator layers and an antenna radiating element between the electrical insulator layers; and
electrically connecting the antenna radiating element to an electrical connection point on the cover for electrical coupling to the wireless access point.

19. The method of claim 18, further comprising providing an opening in the cover, the opening being for an electrical connector.

20. The method of claim 19, wherein the electrical connector is selected from the group consisting of a network port receptacle, a telephone jack, and a power outlet.
